(19) United States
(12) Patent Application Publication
(10) Pub. No.: US 2006/0093990 A1
(43) Pub. Date: May 4, 2006

(54) Chair side apparatus for the collection of dental wastewater

(76) Inventors: Mark E. Stone, Wilmette, IL (US); Lawrence F. Nytz, Bismarck, ND (US)

Correspondence Address: NAVAL MEDICAL RESEARCH CENTER;ATTN: (CODE 00L), 503 ROBERT GRANT AVENUE, SILVER SPRING, MD, 20910-7500, US

(21) Appl. No.: 11/256,279

(22) Filed: Oct. 19, 2005

Related U.S. Application Data
(60) Provisional application No. 60/622,848, filed on Oct. 29, 2004.

(51) Int. Cl. A61C 17/06

(52) U.S. Cl. 433/92

(57) ABSTRACT

The invention relates to a dental chair side wastewater collection system for dental-unit wastewater for sample analysis or collection and management of dental-unit wastewater hazardous materials. The system is small enough to be installed chair side to permit collection of an entire days wastewater or wastewater from a single patient for immediate disposal or for sample collection. Collected wastewater can then be easily emptied and stored elsewhere until disposed.

### CROSS REFERENCE TO RELATED APPLICATION

This application claims priority to U.S. Provisional application 60/622,848 filed Oct. 29, 2004.

### BACKGROUND OF INVENTION

1. Field of the Invention

The inventive subject matter relates to an apparatus and method for the collection of dental wastewater during dental procedures without interrupting the dental vacuum system.

2. Description of Related Art

Hg is generally found in three forms: elemental, inorganic and organic. Each form possesses its own characteristic toxicokinetics and human health effects. Elemental Hg volatilizes at room temperature and human exposure is primarily through inhalation of the vapor. Hg vapor is lipid soluble and easily crosses alveolar membranes of the lungs. Consequently, the Hg is taken up by red blood cells and transported to the central nervous system (Stone, et al, 2003).

Inorganic Hg (also known as ionic Hg) is absorbed by the gastrointestinal tract in humans in only limited amounts. Only approximately 7% of ingested inorganic Hg is absorbed (Stone, et al, 2003) with kidney tissue accumulating the highest concentration. However, elemental Hg in human saliva can be oxidized to ionic Hg, which may be protective since ionic Hg is less toxic (Liang and Brooks, 1995).

Organic Hg is the most environmentally important form of Hg. Organic Hg produces neurotoxic effects in adults. Additionally, the toxic effects on fetuses and young children is particularly acute due to the toxic effects on the developing nervous systems (Stone et al, 2003; Vogel, et al, 1985). Absorption of organic Hg can be as high as 95% with a marked affinity for the central nervous system (Vogel, et al, 1985; Steuerwal, et al, 2000).

The environmental impact of mercury (Hg) release from dental operations is frequently dismissed due to the assumption that Hg in dental amalgam is unavailable for uptake by biologic organisms. The environmental significance of dental Hg was predicated on the assumption that dental Hg in dental amalgam is unavailable for uptake by biological organisms (Berthold, 2001). Recently, however, this notion has been dispelled (Arenholt-Bindslev, 1992; Stone, et al, 1999; Fan, et al, 1997).

Previous dental collection systems are designed to remove particulate waste (amalgam separators), or both particulate and dissolved waste, from the dental wastewater slurry using a combination of gravity sedimentation, filtration, chemical oxidation, and ion-exchange materials (U.S. Pat. No. 3,138,873 to Bishop; U.S. Pat. No. 3,777,403 to Ritchie; U.S. Pat. No. 5,885,076 to Ralls, et al; U.S. Pat. No. 4,385,891 to Ligotti; U.S. Pat. No. 5,205,743 to Ludvigsson, et al; and U.S. Pat. No. 5,795,159 to Ralls, et al).

The apparatus disclosed by U.S. patents to Ludvigsson, et al (U.S. Patent No. 5,205,743) and to Ralls, et al (U.S. Pat. No. 5,885,076) are relatively complex systems where waste material is passed through a series of filters. The apparatus disclosed by the U.S. patent to Bishop (U.S. Pat. No. 3,138,873) describes a system wherein slurry is passed through a porous bag that traps and collects particulate matter. The apparatus disclosed in U.S. Pat. No. 3,777,403 (to Richie) utilizes a system wherein liquid slurry is drawn by vacuum through a collection container and out the vacuum riser and into the drainage system. In U.S. Pat. No. 4,385,891 (to Ligotti), particulate matter settling to the bottom of a canister is enhanced by multiple aperatures in a baffle, separating the canister into two sections. Liquid is drawn out of the canister but particulate matter is allowed to settle and which is ultimately collected. The latter (i.e. U.S. Pat. No. 5,795,159 to Ralls, et al) is also designed to provide remove particulate matter and trapped in a seal-able container while liquid is passed through the system.

The systems previously disclosed either require filtering or pass liquid slurry through the apparatus for disposal via the normal drainage system or other collection methods. Furthermore, the more complex systems operate with various efficiencies and complexity depending on particulate size distribution and flow rate. The most effective mercury removal systems are typically centrally located collection systems such as found in U.S. Pat. No. 5,885,076 to Ralls, et al and U.S. Pat. No. 6,521,131 to Hamilton, et al.

Centrally located systems, while often effective at removing total mercury from dental wastewater suffer a number of disadvantages, even under optimum conditions. These include:
1) location of the apparatus at a distance from the source (i.e. the dental chair),which allows amalgam and mercury to settle and accumulate in dental office plumbing lines, eventually rendering these lines a hazardous waste material in themselves;
2) requirement to accurately size the system relative to the number of dental chairs serviced, total wastewater accumulation and amount of amalgam waste produced per unit of time;
3) complexity of installation;
4) accumulation over time of amalgam waste sludge in settling tanks in addition to the collection within the filters;
5) and complexity of chemical interactions that can occur over time, especially within holding tanks, between various materials, disinfectants, and chemicals used in the practice of dentistry (and contained within the wastewater slurry), and bacteria and waste materials that accumulate in settling tanks in constant contact with the wastewater slurry containing same (these interactions can produce compounds resistant to removal by the apparatus or even serve as an environment that fosters bacterial conversion of inorganic elemental mercury to organic methyl mercury).

Therefore, large centrally located systems necessitate dental clinics from discharging hazardous waste into sewer systems or require the dental office to install expensive dental amalgam separators. A need, therefore, exists for collection systems that generate small volumes of wastewater for easier and less expensive waste management and sample collection. This can be achieved via a chairside collection system that is capable of separating of dental amalgam as particulate matter for easy transport to an off-site facility for storage or to remove harmful pollutants. Additionally, such a system can be utilized for collection of dental wastewater for clinical or laboratory sample analysis.

### SUMMARY OF THE INVENTION

The inventive subject matter relates to a self-contained mercury filtration system that can effectively remove mercury particulate and finely dispersed particles from dental wastewater suction lines and permit collection of the wastewater and particulate matter.

The inventive subject matter also relates to a self-contained waste collection system for chairside use that is contained within or attached to a dental chair or dental unit in line with the existing high vacuum evacuation (HVE) suction line.

The inventive subject matter further relates to a self-contained a dental chair wastewater collection system that generates low volumes of dental wastewater.

The inventive subject matter additionally relates to a self-contained mercury filtration container that can be safely removed and replaced at regular intervals for transport to off-site treatment and management of hazardous materials.

### BRIEF DESCRIPTION OF THE DRAWINGS

FIG. 1 is a drawing of the collection container showing the operational relationship to patient, inlet line and vaccum.

FIG. 2 is a cross-sectional view of the inlet apparatus connected to the collection container.

FIG. 3 is a cross-sectional view of the inlet apparatus.

### DESCRIPTION OF PREFERRED EMBODIMENTS

The invention contemplates a simple dental wastewater collection system intended for placement in-line with an existing High Vacuum Evacuation (HVE) suction line in dental units that is capable of collecting wastewater and dental waste particulate matter. The inventive apparatus is capable of collecting dental waste, chair side, without waste flowing from the apparatus into the vacuum line and drainage system.

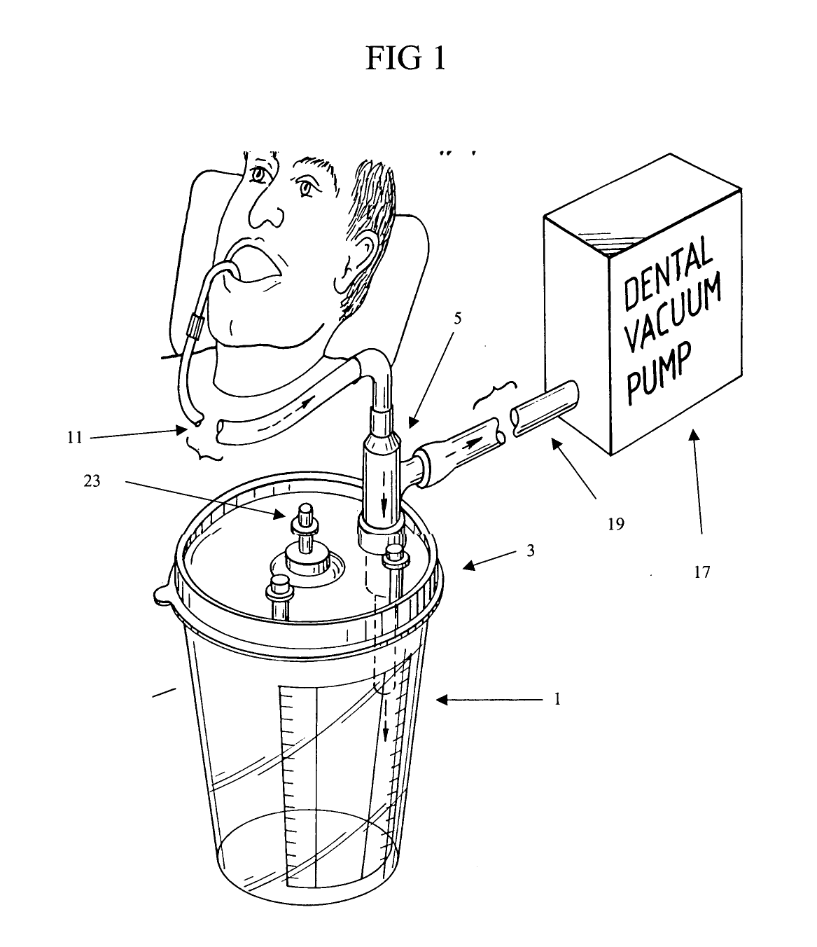

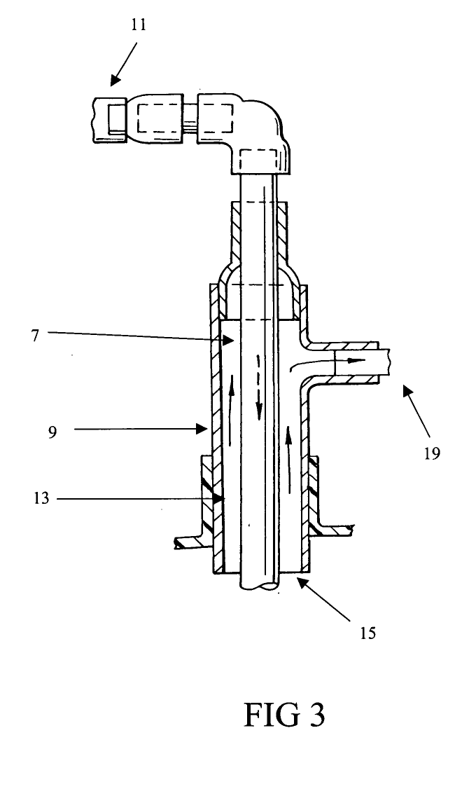

An example of the inventive apparatus is illustrated in FIGS. 1, 2 and 3. The apparatus contains a container (1) capable of holding dental evacuation wastewater and dental-waste particulate matter. The container is of suitable size for holding an adequate volume of waste from a dental patient or multiple dental patients. A preferred size is 1-2 liters in size. However, any size container be used. The container is constructed of any number of materials, including metal, glass or plastic. The container, containing an inside portion, and outside portion and an upper and bottom portion and lid (3) connected to upper portion. The container (1) contains a gasket (21) around the inside of the lid in order to permit a tight seal and maintenance of pressure until released. The container also contains a pressure release value (23) to permit easy disconnect from the vacuum tube (19) to permit transport and emptying of contents or the re-attachment of a replacement container.

Connected and protruding through the lid (3) and into the container (1) is an inlet apparatus (5). The inlet apparatus contains an inside (7) and outside portion (9). The inside portion (7) of the inlet apparatus (5) is disposed lengthwise through the inlet apparatus and is operationally connected to an inlet line (11) from the patient. The outside portion (9) of the inlet apparatus forms a space (13) between the inside portion (7) and the outside portion (9). The space (13) protrudes into the container (1) such that the inlet apparatus space (13) contains an opening (15) exposed to the inside of the container (1). The space (13) is also operationally connected to a vacuum line operationally connected to a vacuum source (17) via a vacuum tube (19). The inside portion (7) also protrudes into the container (1) such that wastewater and dental-waste particulate matter is permitted to pass from the patient and into the container (1). The distance of said protrusion of the inside portion (7) of the inlet apparatus (5) into the container must be sufficiently far such that matter flowing out of the inlet portion (7) is not sucked into the opening (15) of said inlet apparatus space (13) and ultimately into the vacuum tube (19). The distance of the protrusion of the inlet portion (7) into the container is dependent on the distance that the inlet apparatus space (13) protrudes into the container (1) and the strength of the vacuum supplied to the container (1) via the vacuum tube (19). The inlet apparatus can be made of any material including glass, metal or plastic.

The representation of each element is diagrammatic. The figures illustrate relative relationships of each of the elements to one another and are general rather than actual. The figures are not representative of precise ratios of dimensions. However, while size (height and circumference) is to some extent variable with respect to desired volume, placement on or next to the dental chair or even dental unit, the total volume of air capacity within the invention must be sufficient suction and flow rate to permit movement of material through the tubes. Placement of the device is primarily intended to be next to the dental chair. However, the device can be placed anywhere as long as sufficient suction is provided by the HVE.

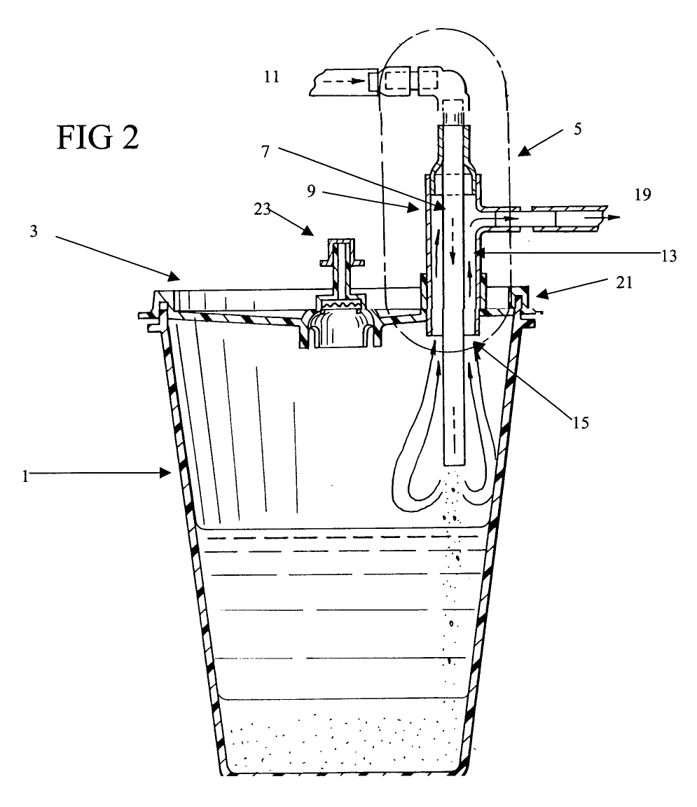

Removal and collection of dental wastewater and particulate matter can be achieved by drawing dental waste, as a liquid slurry, from the patient into the above described apparatus. Particulate matter and liquid is deposited, by gravity, into the container (1) of FIG. 1 and 2. Vacuum to the container is maintained by a vacuum line supplied to the opening to the container in the inlet apparatus (15) by the vacuum pump (17) via the vacuum tube (19). The contents of a nearly full container (1) is either emptied into another container for storage or transport to a treatment facility or the container (1) replaced with a new container. Detachment of the full container is accomplished by first releasing the vacuum via the pressure release value (23) and removing the lid (3).

Liquid and/or particulate matter samples, such as dental amalgam or mercury, can be collected from the container following dental procedures. Samples, containing both particulate matter and liquid can be collected directly as described above. However, samples containing only particulate matter or liquid without large particulate matter can also be collected by first allowing the particulate matter, such as dental amalgam, to settle to the bottom of the container (1). After the particulate matter has settled to the bottom, the liquid wastewater is either poured or aspirated off the underlying particulate matter. The liquid can then be collected and stored for clinical use or, alternatively, deposited in another container for disposal as dental-waste. Similarly, the particulate matter can be collected, free of liquid wastewater for further use or disposed of as necessary.

The above example is given to illustrate specific applications of the invention including the best mode now known to perform the invention. The example is not intended to limit the scope of the invention described in this application.

### REFERENCES

1. Arenholt-Bindslev, D., (1992) Dental amalgam-environmental aspects. Adv. Dent Res. 6: 125-30.

2. Berthold M., (2001) Proven track record: Science shows dental amalgam is safe, effective. ADA News 32 (13):13. Comment by Rodway J. Mackert, Jr. DMD, Ph.D.

3. Bishop, Harold P. 1964. Vacuum attachment for dental aspirator unit. U.S. Pat. No. 3,138,873 issued Jun. 30, 1964.

4. Fan, P. L., D. Arenbolt-Bindslev, G. Schmalz, S. Halback, H. Berendsen, (1997) Environmental issues in dentistry-mercury. Int. Dent. J. 47: 105-9.

5. Hamilton, Richard A., Scott P. Fulton, Ted M. Shields. 2003. Combined oxidation and chelating adsorption system for removal of mercury from water. U.S. Pat. No. 6,521,131 Feb. 18, 2003.

6. Liang, L., R. J. Brooks, (1995) Mercury reactions in the human mounth with dental amalgams. Water Air and Soil Pollut, 80: 103-7.

7. Ligotti, Eugene, F. 1983. Dental apparatus for preventing loss of precious metal particles. U.S. Pat. No. 4,385,891 issued May 31, 1983.

8. Ludvigsson, Bjorn M., D. L. Stromberg. 1993. Dental treatment method. U.S. Pat. No. 5,205,743 issued Apr. 27, 1993.

9. Ralls, Stephen Alden, William Corry Roddy. 1998. Mercury removal method and apparatus. U.S. Pat. No. 5,795,159 issued Aug. 18, 1998.

10. Ralls, Stephen Alden, William Corry Roddy, Ernest David Pederson. 1999. Method and system for removing mercury from dental waste water. U.S. Pat. No. 5,885,076 issued Mar. 23, 1999.

11. Ritchie, John, K. 1973. Dental silver retrieval apparatus. U.S. Pat. No. 3,777,403 issued Dec. 11, 1973.

12. Steuerwal, U., P. Weihe, P. J. Jorgensen, K. Bjerve, J. Brock, B. Heinzow, E. Budtz-Jorgensen, P. Grandjean, (2000) Maternal seafood diet, methyl mercury exposure, and neonatal neurologic function. J. Pediatr. 136(5): 599-605.

13. Stone, M. E., M. E. Cohen, L. Liang, P. Pang, (2003) Determination of methyl mercury in dental-unit wastewater. Dental Materials 19: 675-679.

14. Stone, M. E., E. D. Pederson, G. K. Jones, J. C. Ragain, R. S. Karaway, R. A. Auxer, S. L. Davis, (1999) Mercury removal from the dental-unit wastewater stream. Proceedings of specialty conference: mercury in the environment. Air and waste management association in conjunction with the EPA, Sep. 15-17, Minn. Minnesota, VIP-91: 413-24.

15. Vogel, D. G., R. L. Margolis, N. K. Mottet, (1985) The effects of methyl mercury binding to microtubules. Toxicol Appl Pharmacol., 80: 473-86.

What is claimed is:

1. A chair side dental wastewater evacuation apparatus comprising:
a. a container, having an inside portion, and outside portion and an upper and bottom portion and lid connected to upper portion, said container capable of holding dental evacuation wastewater and dental-waste particulate matter;
b. an inlet apparatus connected to said lid of said container wherein said inlet apparatus contains an inside and outside portion, said inside portion disposed lengthwise through inlet apparatus that is operationally connected to an inlet line from the patient and that protrudes into said container, such that said wastewater and said dental-waste particulate matter passes from said patient and into the container, said outside portion of said inlet apparatus forming a space between said inside portion and said outside portion with said space containing an opening exposed to the inside of said container and with said outside portion connected to an outlet that is operationally connected to a vacuum line operationally connected to a vacuum source.

2. The chair side dental wastewater evacuation apparatus as in claim 1, wherein said upper portion is a lid made of flexible material and is capable of being attached to the said container without other fasteners.

3. The chair side dental wastewater evacuation apparatus as in claim 1, wherein the container is made of materials selected from the group consisting of glass, plastic, fiberglass, polyvinyl chloride, polyethylene, polypropylene, metal and porcelain.

4. The chair side dental wastewater evacuation apparatus as in claim 1, wherein said outside portion of said container contains graduations for measuring liquid volume of said container contents.

5. The chair side dental wastewater evacuation apparatus as in claim 1, wherein said inlet apparatus is made of materials selected from the group consisting of glass, plastic, fiberglass, polyvinyl chloride, polyethylene, polypropylene, metal and porcelain.

6. The chair side dental wastewater evacuation apparatus as in claim 1, wherein said inlet apparatus permits the deposition of said wastewater and said dental-waste particulate matter into said container without said wastewater and said dental-waste particulate matter passing into said vacuum line.

7. A method for chair side collecting and separating insoluble solid particulate matter from dental wastewater comprising the steps;
a. supplying the dental wastewater to a chair side container under vacuum via dental aspiration from a dental patient;
b. permitting said insoluble solid particulate matter to settle to the bottom of said container;
c. collecting said dental wastewater overlaying said insoluble solid particulate matter by pouring off or aspirating off said overlaying liquid into another container;
d. collecting said insoluble solid particulate matter.

8. The method of claim 7 wherein said collection of dental wastewater is further made free of particulate matter by a further step of filtering said poured or said aspirated wastewater.

9. The method of claim 7, wherein said dental insoluble solid particulate matter is dental amalgam or mercury.
